(19) United States
(12) Patent Application Publication
(10) Pub. No.: US 2012/0110681 A1
(43) Pub. Date: May 3, 2012

(54) SYSTEMS FOR EMAIL COMMUNICATIONS

(76) Inventor: Yat Wai Edwin Kwong, Hong Kong (HK)

(21) Appl. No.: 12/938,805

(22) Filed: Nov. 3, 2010

(51) Int. Cl. G06F 21/00; G06F 15/16

(52) U.S. Cl. 726/30; 709/206

(57) ABSTRACT

Systems and methods are provided for email communications between senders and receivers. In accordance with one implementation, a computerized method is provided that allows composing an email by a sender in Send Location of Send City at Send Time through the sender's mobile device. In the implementation, in composing the email, the sender's company may monitor the sender's Send Location, without awareness of the sender. In addition, when composing the email, the GPS receiver included in the sender's mobile device may be configured to locate the Send Location. Moreever, to prevent the sender's realization that the sender is being monitored, the Send location may be included only as header information of the composing email of the composing email.

### BACKGROUND

I. Technical Field

The present invention generally relates to the field of email communications between senders and receivers. Specifically, and without limitation, the invention relates to systems and methods that provide location-based messaging communications between senders and receivers.

II. Background Information

Current messaging systems allow messaging communications for users situated in various locations. Email messaging is arguably the most common form of messaging communication. Students can communicate with their student counterparts using emails at school; office workers use emails to send office memos on a daily basis; moreover, emails are frequently used as tools for advertising by companies in order to promote their commercial goods to consumers.

Even though emails have been used extensively, current systems, however, do not support location-based features for users to send emails based on the specific locations where the users are situated. As an example, there is no way, from present systems, to know where a given message was sent from a sender. Also, there is no way, from present systems, to know where a message was received or read from an intended receiver. Moreover, current email systems do not support allowing email readers to tell the date and time of receiving an email with respect to not only the location of receiving the email but the date and time of the email.

In view of the foregoing shortcoming, there is a need for systems and methods that support email communications based on locations of users. There is also a need for systems and methods that can provide information with respect to the location where a given email is sent by a user. In addition, there is a need for a solution that provides information related to the location where a given email is read by a user.

### SUMMARY

Consistent with embodiments of the present invention, a messaging system for email communications between senders and receivers is provided. The system comprises a sender's mobile device, a receiver's mobile device, a processing means for executing by computing means, and a memory means.

According to all embodiments, the memory means may be configured to compose an email by a sender in Send Location of Send City at Send Time through the sender's mobile device, the sender's mobile device including a GPS receiver. In one embodiment, the composing of the email further includes monitoring, by a sender's company, the sender's Send Location, without awareness of the sender. When composing the email, the GPS receiver included in the sender's mobile device may be configured to locate the Send Location. In addition, to prevent the sender's realization that the sender is being monitored, the Send location may be included only as header information of the composing email but not as content information of the composing email.

The sender may further send the email to an intended receiver. According to one embodiment, after sending the email by the sender to an intended receiver, the sender's company may monitor the sender's Send Location, wherein the monitoring includes using the SMTP server established by the sender's company. Further, when received the sent email, the monitoring further includes retrieving the sender's information with respect to the Send Location and the Send City of the sent email, for record purposes to ensure whether the sender has violated the sender's company policies regarding the allowed Send Location and the allowed Send City.

Further to the embodiment, if the sender has violated the sender's company policies regarding the allowed Send Location and the allowed Send City, the sender's mobile device is disabled. The SMTP server may also disable the sender, wherein the disable feature is only limited to the sender's current Send Location and the Send City, and re-allowing the sender to send emails through the SMTP server is permissible after the sender has moved to a location with a different Send Location and a different Send City. More, in such a case, the disable feature may be limited to all locations for this sender, and the sender cannot send emails to any other receivers through the sender's mobile device, to prevent the sender's mobile device from being stolen from other unauthorized parties.

Even further to the embodiment, If the sender has not violated the sender's company policies regarding the allowed Send Location and the allowed Send City, the SMTP may be allowed to continue to forward the sent email to the intended receiver, wherein before forwarding the sent email to other SMTP servers, the SMTP server may remove the information with respect to the Send Location and the Send City, to prevent the intended receiver from realizing that the sender and the Send Location and the Send City are being monitored.

After an email has been sent by a sender, the intended receiver may be configured to receive the email. In one embodiment, the email may be received by the receiver in Receive Location of Receive City at Receive Time through the receiver's mobile device, in which the receiver's mobile device may include a GPS receiver. In an additional embodiment, the receiver's mobile device may display, on the receiver's mobile device, information from the received email including the Receive Time, in UTC format, after fetching the received information from a header of the received email. Alternatively, however, the receiver's mobile device may display, on the receiver's mobile device, information from the received email including the Receive Time, in UTC format, after fetching the received information from a header of the received email. The receiver's mobile device may further display not only the Receive Time in local format but also the Receive Location and the Receive City.

In yet another embodiment, the receiver's mobile device may display, on the receiver's mobile device, information from the received email including the Receive Time, in UTC format, after fetching the received information from a header of the received email. The device may further display not only the Receive Time in local format but also the Receive Location and the Receive City; and ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein If the receiver has violated the sender's controls, the receiver's mobile device would be disabled; the receiver would by disabled through receiver's incoming server, wherein the disable feature is only limited to the receiver's current Receive Location and the Receive City; and re-allowing the receiver to receive emails through the incoming server after the receiver has moved to a location with a different Receive Location and a different Receive City.

In a further embodiment, the receiver's mobile device may display, on the receiver's mobile device, information from the received email including the Receive Time, in UTC format, after fetching the received information from a header of the received email; further displays not only the Receive Time in local format but also the Receive Location and the Receive City; and ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein If the receiver has violated the sender's controls, disabling the receiver through the receiver's mobile device to prevent the receiver from receiving highly secured emails, such as encrypted emails, other unencrypted emails being accessible to the receiver.

Additionally, another embodiment may include having the receiver's mobile device to display, on the receiver's mobile device, information from the received email including the Receive Time, in UTC format, after fetching the received information from a header of the received email; further displays not only the Receive Time in local format but also the Receive Location and the Receive City; and ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, where if the receiver has violated the sender's controls, disabling the receiver through the receiver's mobile device to prevent the receiver from receiving from receiving insecure emails, such as unencrypted emails.

A further embodiment may include the receiver's mobile device to display, on the receiver's mobile device, information from the received email including the Receive Time, in UTC format, after fetching the received information from a header of the received email; further displays not only the Receive Time in local format but also the Receive Location and the Receive City; ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein If the receiver has violated the sender's controls, the receiver's mobile device would be disabled; the receiver would by disabled through receiver's incoming server, wherein the disable feature is only limited to the receiver's current Receive Location and the Receive City; and re-allowing the receiver to receive emails through the incoming server after the receiver has moved to a location with a different Receive Location and a different Receive City; and limiting the disable feature to all locations for this receiver, wherein the receiver cannot receive emails from any other senders through the receiver's mobile device, to prevent the receiver's mobile device from being stolen from other unauthorized parties.

The sender's company may be configured to monitor the sender's Send Location. In a different embodiment, the sender may establish a set of controls to control the intended receiver from reading the composing email in terms of GPS Allowed Areas, GPS Allowed Times, and GPS Allowed Venues, the GPS Allowed Areas including allowed countries and allowed cities, the GPS Allowed Times including Day Time or Night Time, the GPS Allowed Venues including work allowed areas, public allowed areas, and certain highly secured areas. When composing the email, the sender may include Receiving Controlled Information regarding the GPS Allowed Areas, the GPS Allowed Times, and the GPS Allowed Venues; and to prevent the receiver's realization that the receiver's location is being controlled, including the Receiving Controlled Information only in the header of the composing email but not the content of the composing email, so that the Receiving Controlled Information will not be visible to any intended receivers.

According to all embodiments, the receiver may receive a request to re-read the email, after the receiver carrying the receiver's mobile device travels to another new location. In that case, the new location may belong to Another Receive Location of Another Receive City. In one embodiment, the request further includes re-reading, by the receiver, the received email at the another location; displaying on the receiver's mobile device, the Receive Time of the received email based on the another new location but not the Receive Location, wherein the another new location, including the Another Receive Location and Another Receive City, is being reported by the GPS receiver included in the receiver's mobile device; and displaying on the receiver's mobile device, not only the Receive Time in a format based on the another new location but also the Another Receive Location and the Another Receive City.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a flow diagram illustrating an exemplary system of which an email user travels to a different country, consistent with an embodiment of the present invention.

FIG. 2 is a flow diagram illustrating an exemplary system of which a sender's company monitors the sender's email, consistent with an embodiment of the present invention.

### DETAILED DESCRIPTION

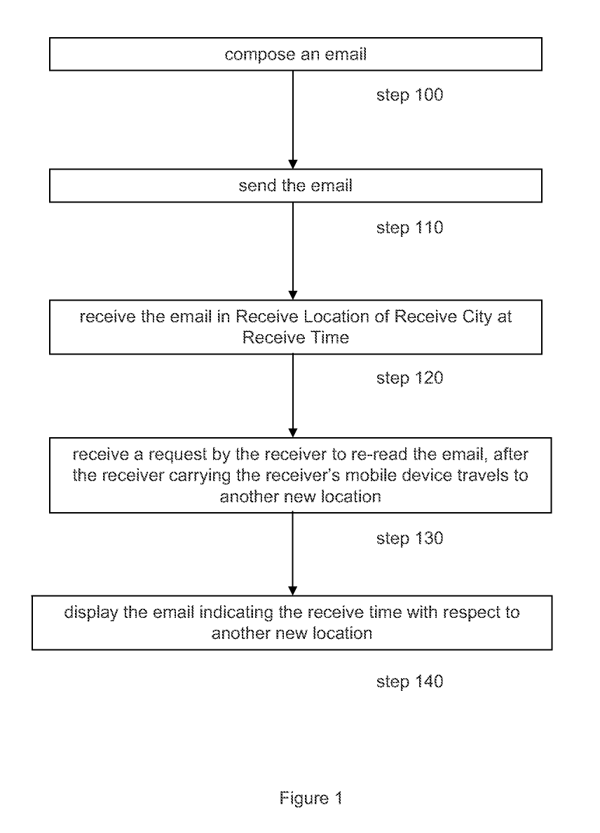

Referring to FIG. 1, a messaging system for email communications between senders and receivers is provided. The system comprises: a sender's mobile device; a receiver's mobile device; a processing means for executing by computing means; a memory means configured to compose an email by a sender in Send Location of Send City at Send Time through the sender's mobile device (step 100), the sender's mobile device including a GPS receiver; send the email by the sender to an intended receiver; receive the email by the receiver in Receive Location of Receive City at Receive Time through the receiver's mobile device (step 110), the receiver's mobile device including a GPS receiver; and receive an request by the receiver to re-read the email, after the receiver carrying the receiver's mobile device travels to another new location (step 120), wherein the another new location belongs to Another Receive Location of Another Receive City.

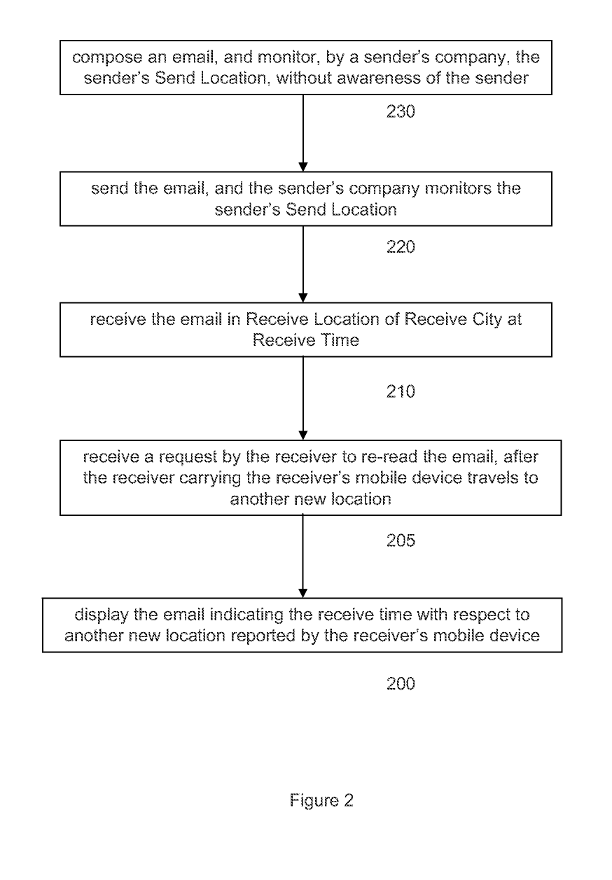

The present invention may be implemented as computer-implemented methods. For example, as illustrated in FIG. 2, the methods may include composing an email by a sender in Send Location of Send City at Send Time through the sender's mobile device, the sender's mobile device including a GPS receiver, wherein composing the email further includes monitoring, by a sender's company, the sender's Send Location, without awareness of the sender (step 230); when composing the email, the GPS receiver included in the sender's mobile device locates the Send Location; and to prevent the sender's realization that the sender is being monitored, including the Send location only as header information of the composing email but not as content information of the composing email; send the email by the sender to an intended receiver (step 220), wherein the sender's company monitors the sender's Send Location, the monitoring includes using the SMTP server established by the sender's company, wherein when received the sent email further includes retrieving the sender's information with respect to the Send Location and the Send City of the sent email, for record purposes to ensure whether the sender has violated the sender's company policies regarding the allowed Send Location and the allowed Send City; receive the email by the receiver in Receive Location of Receive City at Receive Time through the receiver's mobile device (step 210), the receiver's mobile device including a GPS receiver; and receive an request by the receiver to re-read the email, after the receiver carrying the receiver's mobile device travels to another new location (step 205), wherein the another new location belongs to Another Receive Location of Another Receive City.

Additionally, the computer-implemented methods may also include composing an email by a sender in Send Location of Send City at Send Time through the sender's mobile device, the sender's mobile device including a GPS receiver, wherein composing the email further includes monitoring, by a sender's company, the sender's Send Location, without awareness of the sender (step 230); when composing the email, the GPS receiver included in the sender's mobile device locates the Send Location; and to prevent the sender's realization that the sender is being monitored, including the Send location only as header information of the composing email but not as content information of the composing email. Further, the methods may send the email by the sender to an intended receiver (step 220), wherein the sender's company monitors the sender's Send Location, the monitoring includes using the SMTP server established by the sender's company, wherein when received the sent email further includes retrieving the sender's information with respect to the Send Location and the Send City of the sent email, for record purposes to ensure whether the sender has violated the sender's company policies regarding the allowed Send Location and the allowed Send City, wherein if the sender has violated the sender's company policies regarding the allowed Send Location and the allowed Send City, the sender's mobile device is disabled; the SMTP server disables the sender, wherein the disable feature is only limited to the sender's current Send Location and the Send City, and wherein re-allowing the sender to send emails through the SMTP server is permissible after the sender has moved to a location with a different Send Location and a different Send City; and the disable feature is limited to all locations for this sender, the sender cannot send emails to any other receivers through the sender's mobile device, to prevent the sender's mobile device from being stolen from other unauthorized parties; receive the email by the receiver in Receive Location of Receive City at Receive Time through the receiver's mobile device (step 210), the receiver's mobile device including a GPS receiver; and receive an request by the receiver to re-read the email (step 205), after the receiver carrying the receiver's mobile device travels to another new location, wherein the another new location belongs to Another Receive Location of Another Receive City.

Further, the methods may comprise sending the email by the sender to an intended receiver, wherein the sender's company monitors the sender's Send Location (step 230), the monitoring includes using the SMTP server established by the sender's company, wherein when received the sent email further includes retrieving the sender's information with respect to the Send Location and the Send City of the sent email, for record purposes to ensure whether the sender has violated the sender's company policies regarding the allowed Send Location and the allowed Send City, wherein If the sender has violated the sender's company policies regarding the allowed Send Location and the allowed Send City, the sender's mobile device is disabled; the SMTP server disables the sender, wherein the disable feature is only limited to the sender's current Send Location and the Send City, and wherein re-allowing the sender to send emails through the SMTP server is permissible after the sender has moved to a location with a different Send Location and a different Send City; and the disable feature is limited to all locations for this sender, the sender cannot send emails to any other receivers through the sender's mobile device, to prevent the sender's mobile device from being stolen from other unauthorized parties; and If the sender has not violated the sender's company policies regarding the allowed Send Location and the allowed Send City, the SMTP continues to forward the sent email to the intended receiver, wherein before forwarding the sent email to other SMTP servers, the SMTP server removing the information with respect to the Send Location and the Send City, to prevent the intended receiver from realizing that the sender and the Send Location and the Send City are being monitored; receive the email by the receiver in Receive Location of Receive City at Receive Time through the receiver's mobile device (step 210), the receiver's mobile device including a GPS receiver; and receive an request by the receiver to re-read the email (step 205), after the receiver carrying the receiver's mobile device travels to another new location, wherein the another new location belongs to Another Receive Location of Another Receive City.

Moreover, the methods may include retrieving the sender's information with respect to the Send Location and the Send City of the sent email, for record purposes to ensure whether the sender has violated the sender's company policies regarding the allowed Send Location and the allowed Send City, wherein If the sender has violated the sender's company policies regarding the allowed Send Location and the allowed Send City, the sender's mobile device is disabled; the SMTP server disables the sender, wherein the disable feature is only limited to the sender's current Send Location and the Send City, and wherein re-allowing the sender to send emails through the SMTP server is permissible after the sender has moved to a location with a different Send Location and a different Send City; and the disable feature is limited to all locations for this sender, the sender cannot send emails to any other receivers through the sender's mobile device, to prevent the sender's mobile device from being stolen from other unauthorized parties; and if the sender has not violated the sender's company policies regarding the allowed Send Location and the allowed Send City, the SMTP continues to forward the sent email to the intended receiver, wherein before forwarding the sent email to other SMTP servers, the SMTP server removing the information with respect to the Send Location and the Send City, to prevent the intended receiver from realizing that the sender and the Send Location and the Send City are being monitored; receive the email by the receiver in Receive Location of Receive City at Receive Time through the receiver's mobile device (step 210), the receiver's mobile device including a GPS receiver, wherein the receiver's mobile device displays (step 200), on the receiver's mobile device, information from the received email including the Receive Time, in UTC format, after fetching the received information from a header of the received email; and receive an request by the receiver to re-read the email (step 205), after the receiver carrying the receiver's mobile device travels to another new location, wherein the another new location belongs to Another Receive Location of Another Receive City.

Further, a different implementation of the methods may include sending the email by the sender to an intended receiver, wherein the sender's company monitors the sender's Send Location, the monitoring includes using the SMTP server established by the sender's company, wherein when received the sent email further includes retrieving the sender's information with respect to the Send Location and the Send City of the sent email, for record purposes to ensure whether the sender has violated the sender's company policies regarding the allowed Send Location and the allowed Send City, wherein if the sender has violated the sender's company policies regarding the allowed Send Location and the allowed Send City, the sender's mobile device is disabled; the SMTP server disables the sender, wherein the disable feature is only limited to the sender's current Send Location and the Send City, and wherein re-allowing the sender to send emails through the SMTP server is permissible after the sender has moved to a location with a different Send Location and a different Send City (step 205); and the disable feature is limited to all locations for this sender, the sender cannot send emails to any other receivers through the sender's mobile device, to prevent the sender's mobile device from being stolen from other unauthorized parties; and If the sender has not violated the sender's company policies regarding the allowed Send Location and the allowed Send City, the SMTP continues to forward the sent email to the intended receiver, wherein before forwarding the sent email to other SMTP servers, the SMTP server removing the information with respect to the Send Location and the Send City, to prevent the intended receiver from realizing that the sender and the Send Location and the Send City are being monitored; receive the email by the receiver in Receive Location of Receive City at Receive Time through the receiver's mobile device (step 210), the receiver's mobile device including a GPS receiver, wherein the receiver's mobile device: displays information from the received email including the Receive Time, in local format, but not UTC format (step 200), after fetching the received information from a header of the received email and calculating the Receive Time in local format in view of the Receive Location reported by the GPS receiver included in the receiver's mobile device; and further displays not only the

Receive Time in local format but also the Receive Location and the Receive City; and receive an request by the receiver to re-read the email (step 205), after the receiver carrying the receiver's mobile device travels to another new location, wherein the another new location belongs to Another Receive Location of Another Receive City.

Furthermore, the methods may include displaying (step 200), on the receiver's mobile device, information from the received email including the Receive Time, in UTC format, after fetching the received information from a header of the received email; further displays not only the Receive Time in local format but also the Receive Location and the Receive City; and ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein if the receiver has violated the sender's controls, disabling the receiver through the receiver's mobile device to prevent the receiver from receiving highly secured emails, such as encrypted emails, other unencrypted emails being accessible to the receiver.

Alternatively, the methods may include displaying, on the receiver's mobile device, information from the received email including the Receive Time, in UTC format, after fetching the received information from a header of the received email; further displays not only the Receive Time in local format but also the Receive Location and the Receive City; and ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein if the receiver has violated the sender's controls, disabling the receiver through the receiver's mobile device to prevent the receiver from receiving from receiving insecure emails, such as unencrypted emails.

In a further modification, the methods include displaying (step 200), on the receiver's mobile device, information from the received email including the Receive Time, in UTC format, after fetching the received information from a header of the received email; further displays not only the Receive Time in local format but also the Receive Location and the Receive City; ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein if the receiver has violated the sender's controls, the receiver's mobile device would be disabled; the receiver would by disabled through receiver's incoming server, wherein the disable feature is only limited to the receiver's current Receive Location and the Receive City; and re-allowing the receiver to receive emails through the incoming server after the receiver has moved to a location with a different Receive Location and a different Receive City; and limiting the disable feature to all locations for this receiver, wherein the receiver cannot receive emails from any other senders through the receiver's mobile device, to prevent the receiver's mobile device from being stolen from other unauthorized parties.

On a different example, the methods include establishing a set of controls by the sender to control the intended receiver from reading the composing email in terms of GPS Allowed Areas, GPS Allowed Times, and GPS Allowed Venues, the GPS Allowed Areas including allowed countries and allowed cities, the GPS Allowed Times including Day Time or Night Time, the GPS Allowed Venues including work allowed areas, public allowed areas, and certain highly secured areas; when composing the email, the sender including Receiving Controlled Information regarding the GPS Allowed Areas, the GPS Allowed Times, and the GPS Allowed Venues; and to prevent the receiver's realization that the receiver's location is being controlled, including the Receiving Controlled Information only in the header of the composing email but not the content of the composing email, so that the Receiving Controlled Information will not be visible to any intended receivers.

The example may further include re-reading (step 205), by the receiver, the received email at the another location; displaying on the receiver's mobile device (step 200), the Receive Time of the received email based on the another new location but not the Receive Location, wherein the another new location, including the Another Receive Location and Another Receive City, is being reported by the GPS receiver included in the receiver's mobile device; and displaying on the receiver's mobile device (step 200), not only the Receive Time in a format based on the another new location but also the Another Receive Location and the Another Receive City.

The present techniques and embodiments described herein, including the exemplary systems and methods presented above, can be implemented in digital electronic circuitry, or in computer hardware, firmware, software, or in any suitable combinations thereof. In addition, apparatus and systems consistent with the present invention can be implemented in a computer program product tangibly embodied in a machine-readable storage device for execution by a programmable processor.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. A messaging system for email communications between senders and receivers, the system comprising:
a sender's mobile device;
a receiver's mobile device;
a processing means for executing by computing means; and
a memory means configured to:
compose an email by a sender in Send Location of Send City at Send Time through the sender's mobile device, the sender's mobile device including a GPS receiver;
send the email by the sender to an intended receiver;
receive the email by the receiver in Receive Location of Receive City at Receive Time through the receiver's mobile device, the receiver's mobile device including a GPS receiver; and
receive a request by the receiver to re-read the email, after the receiver carrying the receiver's mobile device travels to another new location, wherein the another new location belongs to Another Receive Location of Another Receive City.

2. The system of claim 1, wherein
the composing of the email further includes:
monitoring, by a sender's company, the sender's Send Location, without awareness of the sender;
when composing the email, the GPS receiver included in the sender's mobile device locating the Send Location; and
to prevent the sender's realization that the sender is being monitored, including the Send location only as header information of the composing email but not as content information of the composing email; and
the sending of the email by the sender to an intended receiver,
the sender's company monitors the sender's Send Location, wherein the monitoring includes using the SMTP server established by the sender's company, wherein when received the sent email further includes:
retrieving the sender's information with respect to the Send Location and the Send City of the sent email, for record purposes to ensure whether the sender has violated the sender's company policies regarding the allowed Send Location and the allowed Send City.

3. The system of claim 2, wherein
the ensuring of whether the sender has violated the sender's company policies regarding the allowed Send Location and the allowed Send City,
If the sender has violated the sender's company policies regarding the allowed Send Location and the allowed Send City,
the sender's mobile device is disabled;
the SMTP server disables the sender, wherein the disable feature is only limited to the sender's current Send Location and the Send City, and wherein re-allowing the sender to send emails through the SMTP server is permissible after the sender has moved to a location with a different Send Location and a different Send City; and
the disable feature is limited to all locations for this sender, the sender cannot send emails to any other receivers through the sender's mobile device, to prevent the sender's mobile device from being stolen from other unauthorized parties.

4. The system of claim 3, wherein
the ensuring of whether the sender has violated the sender's company policies regarding the allowed Send Location and the allowed Send City,
If the sender has violated the sender's company policies regarding the allowed Send Location and the allowed Send City,
the sender's mobile device is disabled;
the SMTP server disables the sender, wherein the disable feature is only limited to the sender's current Send Location and the Send City, and wherein re-allowing the sender to send emails through the SMTP server is permissible after the sender has moved to a location with a different Send Location and a different Send City; and
the disable feature is limited to all locations for this sender, the sender cannot send emails to any other receivers through the sender's mobile device, to prevent the sender's mobile device from being stolen from other unauthorized parties; and
If the sender has not violated the sender's company policies regarding the allowed Send Location and the allowed Send City,
the SMTP continues to forward the sent email to the intended receiver, wherein before forwarding the sent email to other SMTP servers, the SMTP server removing the information with respect to the Send Location and the Send City, to prevent the intended receiver from realizing that the sender and the Send Location and the Send City are being monitored.

5. The system of claim 4, wherein
the receiving of the email by the receiver in Receive Location of Receive City at Receive Time through the receiver's mobile device,
the receiver's mobile device displays, on the receiver's mobile device, information from the received email including the Receive Time, in UTC format, after fetching the received information from a header of the received email.

6. The system of claim 4, wherein
the receiving of the email by the receiver in Receive Location of Receive City at Receive Time through the receiver's mobile device,
the receiver's mobile device:
displays, on the receiver's mobile device, information from the received email including the Receive Time, in UTC format, after fetching the received information from a header of the received email; and
further displays not only the Receive Time in local format but also the Receive Location and the Receive City.

7. The system of claim 4, wherein
the receiving of the email by the receiver in Receive Location of Receive City at Receive Time through the receiver's mobile device,
the receiver's mobile device:
displays, on the receiver's mobile device, information from the received email including the Receive Time, in UTC format, after fetching the received information from a header of the received email;
further displays not only the Receive Time in local format but also the Receive Location and the Receive City; and
ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein
If the receiver has violated the sender's controls,
the receiver's mobile device would be disabled;
the receiver would by disabled through receiver's incoming server, wherein the disable feature is only limited to the receiver's current Receive Location and the Receive City; and
re-allowing the receiver to receive emails through the incoming server after the receiver has moved to a location with a different Receive Location and a different Receive City.

8. The system of claim 4, wherein
the receiving of the email by the receiver in Receive Location of Receive City at Receive Time through the receiver's mobile device,
the receiver's mobile device:
displays, on the receiver's mobile device, information from the received email including the Receive Time, in UTC format, after fetching the received information from a header of the received email;
further displays not only the Receive Time in local format but also the Receive Location and the Receive City; and
ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein
If the receiver has violated the sender's controls, disabling the receiver through the receiver's mobile device to prevent the receiver from receiving highly secured emails, such as encrypted emails, other unencrypted emails being accessible to the receiver.

9. The system of claim 4, wherein
the receiving of the email by the receiver in Receive Location of Receive City at Receive Time through the receiver's mobile device,
the receiver's mobile device:
displays, on the receiver's mobile device, information from the received email including the Receive Time, in UTC format, after fetching the received information from a header of the received email;
further displays not only the Receive Time in local format but also the Receive Location and the Receive City; and
ensures, by the receiver's mobile device by referring to the header of the email, if the receiver has violated any controls set forth by the sender to control the intended receiver from reading the composing email in terms of GPS
Allowed Areas, GPS Allowed Times, and GPS Allowed Venues, wherein If the receiver has violated the sender's controls, disabling the receiver through the receiver's mobile device to prevent the receiver from receiving from receiving insecure emails, such as unencrypted emails.

10. The system of claim 4, wherein
the receiving of the email by the receiver in Receive Location of Receive City at Receive Time through the receiver's mobile device,
the receiver's mobile device:
displays, on the receiver's mobile device, information from the received email including the Receive Time, in UTC format, after fetching the received information from a header of the received email;
further displays not only the Receive Time in local format but also the Receive Location and the Receive City;
ensures, by the receiver's mobile device by referring to the header of the email, if the receiver has violated any controls set forth by the sender to control the intended receiver from reading the composing email in terms of GPS Allowed Areas, GPS Allowed Times, and GPS Allowed Venues, wherein
If the receiver has violated the sender's controls,
the receiver's mobile device would be disabled;
the receiver would by disabled through receiver's incoming server, wherein the disable feature is only limited to the receiver's current Receive Location and the Receive City; and
re-allowing the receiver to receive emails through the incoming server after the receiver has moved to a location with a different Receive Location and a different Receive City; and
limiting the disable feature to all locations for this receiver, wherein the receiver cannot receive emails from any other senders through the receiver's mobile device, to prevent the receiver's mobile device from being stolen from other unauthorized parties.

11. The system of claim 10, wherein
the monitoring, by the sender's company, of the sender's Send Location,
establishing a set of controls by the sender to control the intended receiver from reading the composing email in terms of GPS Allowed Areas, GPS Allowed Times, and GPS Allowed Venues, the GPS Allowed Areas including allowed countries and allowed cities, the GPS Allowed Times including Day Time or Night Time, the GPS Allowed Venues including work allowed areas, public allowed areas, and certain highly secured areas;
when composing the email, the sender including Receiving Controlled Information regarding the GPS Allowed Areas, the GPS Allowed Times, and the GPS Allowed Venues; and
to prevent the receiver's realization that the receiver's location is being controlled, including the Receiving Controlled Information only in the header of the composing email but not the content of the composing email, so that the Receiving Controlled Information will not be visible to any intended receivers.

12. The system of claim 11, wherein
the receiving of the request by the receiver to re-read the email, the request further includes:
re-reading, by the receiver, the received email at the another location;
displaying on the receiver's mobile device, the Receive Time of the received email based on the another new location but not the Receive Location, wherein the another new location, including the Another Receive Location and Another Receive City, is being reported by the GPS receiver included in the receiver's mobile device; and
displaying on the receiver's mobile device, not only the Receive Time in a format based on the another new location but also the Another Receive Location and the Another Receive City.
